(19) United States
(12) Patent Application Publication
(10) Pub. No.: US 2019/0303875 A1
(43) Pub. Date: Oct. 3, 2019

(54) INFORMATION PROCESSING SYSTEM, INFORMATION PROCESSING APPARATUS, AND INFORMATION PROCESSING METHOD

(71) Applicants: Kohichiroh NISHIKAWA, Kanagawa (JP); Kenta Tamaki, Kanagawa (JP)

(72) Inventors: Kohichiroh NISHIKAWA, Kanagawa (JP); Kenta Tamaki, Kanagawa (JP)

(21) Appl. No.: 16/355,777

(22) Filed: Mar. 17, 2019

(30) Foreign Application Priority Data
Mar. 30, 2018 (JP) 2018-070382

(51) Int. Cl. G06Q 10/10; H04N 1/32; H04N 1/00

(52) U.S. Cl. CPC G06Q 10/107; H04N 1/00949; H04N 1/32368

(57) ABSTRACT

An information processing system executes a workflow including a plurality of processes to be executed in series. The information processing system includes circuitry configured to acquire mail information included in an e-mail and electronic data attached to the e-mail; identify a workflow to be executed based on the mail information; and execute the identified workflow with a use of the electronic data.

### CROSS-REFERENCE TO RELATED APPLICATION

This patent application is based on and claims priority pursuant to 35 U.S.C. § 119(a) to Japanese Patent Application No. 2018-070382, filed on Mar. 30, 2018, in the Japan Patent Office, the entire disclosure of which is hereby incorporated by reference herein.

### BACKGROUND

### Technical Field

The present disclosure relates to an information processing system, an information processing apparatus, and an information processing method.

### Description of the Related Art

A technique is known that stores a file attached to an e-mail as a print job and executes printing for the print job in response to a request from a mail recipient specified as a destination of the e-mail.

### SUMMARY

According to an embodiment, an information processing system executes a workflow including a plurality of processes to be executed in series. The information processing system includes circuitry configured to acquire mail information included in an e-mail and electronic data attached to the e-mail; identify a workflow to be executed based on the mail information; and execute the identified workflow with a use of the electronic data.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a system configuration of an information processing system, according to an embodiment of the present disclosure;

FIG. 2 is a diagram illustrating a hardware configuration of a cloud server, according to an embodiment of the present disclosure;

FIG. 3 is a diagram illustrating function configurations of a cloud server and a mail transfer server, according to an embodiment of the present disclosure;

FIG. 4 is a sequence diagram illustrating an example of steps in an operation performed by the information processing system, according to an embodiment of the present disclosure;

FIG. 5 is a sequence diagram illustrating an example of steps in an operation performed by the information processing system according to an embodiment of the present disclosure;

FIG. 6 is a diagram illustrating an example of a management table held by an application management module, according to an embodiment of the present disclosure;

FIG. 7 is a diagram illustrating an example of mail information transferred from the mail transfer server to the cloud server in the information processing system, according to an embodiment of the present disclosure;

FIG. 8 is a diagram illustrating an example of a user registration information table held by an authentication module, according to an embodiment of the present disclosure;

FIG. 9 is a diagram illustrating an example of an address of a storage destination of an attached file transmitted from a temporary file storage module, according to an embodiment of the present disclosure;

FIG. 10 is a diagram illustrating another example of the address of the storage destination of mail information transmitted from the temporary file storage module, according to an embodiment of the present disclosure;

FIG. 11 is a diagram illustrating an example of a mail information management table held by a mail processing module, according to an embodiment of the present disclosure;

FIG. 12 is a diagram illustrating an example of a setting file of an event notification setting held by an event notification module, according to an embodiment of the present disclosure; and

FIG. 13 is a diagram illustrating an example of an application setting screen displayed on a display device in the cloud server, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, an embodiment of the present disclosure will be described in detail with reference to the drawings.

System Configuration of an Information Processing System 10:

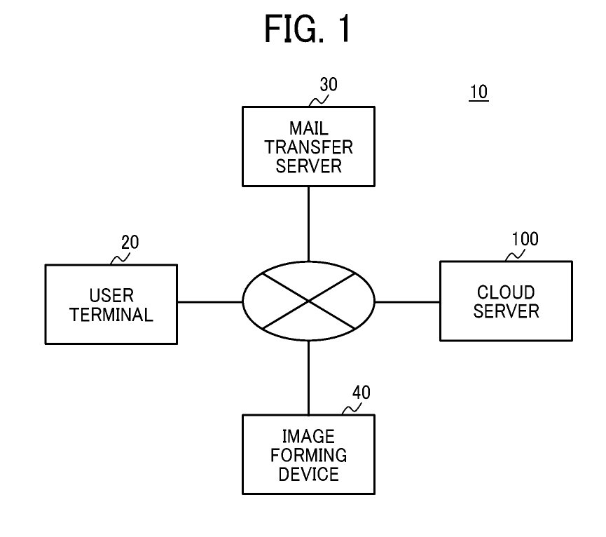

FIG. 1 is a diagram illustrating a system configuration of an information processing system 10 according to an embodiment of the present disclosure. As illustrated in FIG. 1, the information processing system 10 includes a user terminal 20, a mail transfer server 30, an image forming device 40, and a cloud server 100. Each device is connected to a network 12. Examples of the network 12 include a Local Area Network (LAN), a Virtual Private Network (VPN), the Internet, and the like.

The image forming device 40 is a device including a plurality of image processing functions such as a copy function, a scan function, a facsimile function, and a printer function. Examples of the image forming device 40 include a multifunction peripheral (MFP). The image forming device 40 receives a job execution request transmitted from extraneous resources via the network 12 and execute a function corresponding to the job execution request. In addition, the image forming device 40 transmits a job execution result (for example, an electronic file generated by the scan function, etc.) to extraneous resources via the network 12.

The cloud server 100 is an example of an information processing apparatus. The cloud server 100 is a server apparatus that provides a workflow service. The workflow is a series of a plurality of processes executed in cooperation. Examples of the workflow include to provide a service for converting an electronic file into a PDF format and delivering the electronic file to an external storage system. In addition, the image forming apparatus executes a workflow by itself, i.e., performing a plurality of processes in order. For example, the image forming device 40 performs a workflow that attaches an internal confidential stamp to a PDF file and then prints the PDF file. Any suitable process can be included in a series of processes of the workflow. Examples of the processes to be included in the workflow include scan processing, file editing processing, file format conversion processing, print processing, file distribution processing, and file saving processing.

The user terminal 20 is an example of a terminal device. The user terminal 20 is a terminal device used by a user. The user terminal 20 can use the workflow service provided by the cloud server 100 via the network 12. In order to use the workflow service, the user terminal 20 includes, at least, a function for transmitting an e-mail. Examples of the user terminal 20 include a personal computer, a tablet terminal, and a smartphone. The information processing system 10 includes a plurality of the user terminals 20, and each of the plurality of user terminals 20 uses the workflow service provided by the cloud server 100.

The mail transfer server 30 is a server apparatus that provides an e-mail transfer service. For example, the mail transfer server 30 transfers an e-mail transmitted from the user terminal 20 to the cloud server 100.

The information processing system 10 configured as described above causes the cloud server 100 to execute a specific work flow in response to an-email transmitted from the user terminal 20. Specifically, the user terminal 20 transmits an e-mail to which a file is attached. Then, the mail transfer server 30 receives the e-mail, and transfers to the cloud server 100 e-mail information and the attached file included in the e-mail. Upon receiving the mail information and the attached file, the cloud server 100 identifies a workflow to be executed from a plurality of predefined workflows on the basis of the mail information, and executes the identified workflow with the use of the attached file. In other words, in the information processing system 10 according to the present embodiment, a desired workflow is selectively executed among a plurality of workflows by including identification information of the workflow to be executed in the mail information included in the e-mail transmitted from the user terminal 20. This point will be specifically described below.

Hardware Configuration of the Cloud Server 100:

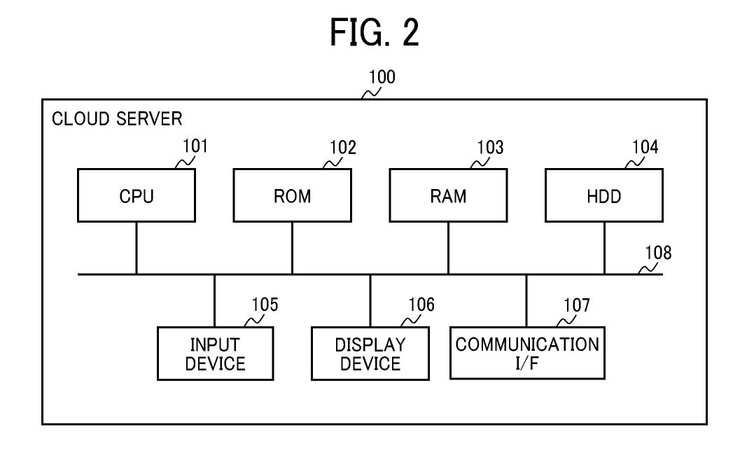

FIG. 2 is a diagram illustrating a hardware configuration of the cloud server 100 according to an embodiment of the present disclosure. As illustrated in FIG. 2, the cloud server 100 includes a central processing unit (CPU) 101, a read only memory (ROM) 102, a random access memory (RAM) 103, a hard disk drive (HDD) 104, an input device 105, a display device 106, and a communication Interface (I/F) 107. Each hardware is mutually connected via a bus 108.

The CPU 101 executes various programs stored in the ROM 102 or the HDD 104. The ROM 102 is a nonvolatile memory. For example, the ROM 102 stores various programs to be executed by the CPU 101, data necessary for the CPU 101 to execute the various programs, and the like. The RAM 103 is a main storage device such as a dynamic random access memory (DRAM) or a static random access memory (SRAM). For example, the RAM 103 functions as a work area used when the CPU 101 executes the various programs. The HDD 104 is a nonvolatile storage device. For example, the HDD 104 stores various programs to be executed by the CPU 101, data necessary for the CPU 101 to execute the various programs, and the like.

The input device 105 inputs various kinds of information by being operated by a user. As the input device 105, for example, a mouse, a keyboard, or the like is used. The display device 106 displays various kinds of information. As the display device 106, for example, a liquid crystal display, an organic EL display, or the like is used. The communication I/F 107 is an interface for communicating with an external information processing apparatus (for example, the user terminal 20, the mail transfer server 30, etc.) via the network 12. The input device 105 and the display device 106 are not limited to a device provided in the cloud server 100 as long as the input device 105 and the display device 106 can input and display to the cloud server 100. For example, the input device 105 and the display device 106 can be a device included in a terminal device (for example, a personal computer, etc.) connected to the cloud server 100 via the network 12.

Function Configurations of the Cloud Server 100 and the Mail Transfer Server 30:

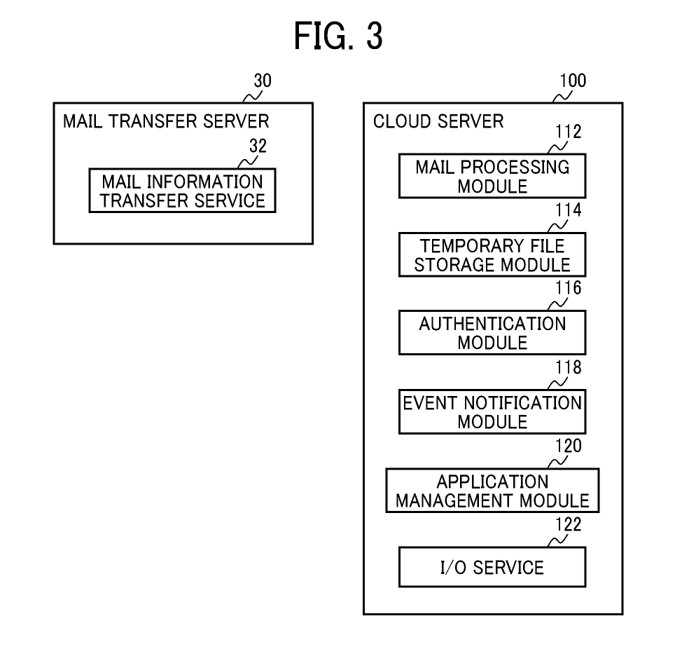

FIG. 3 is a diagram illustrating function configurations of the cloud server 100 and the mail transfer server 30 according to an embodiment of the present disclosure.

As illustrated in FIG. 3, the mail transfer server 30 includes a mail information transfer service 32. The mail information transfer service 32 is an example of a transfer unit. The mail information transfer service 32 receives an e-mail transmitted from the user terminal 20. Then, the mail information transfer service 32 performs various checks (for example, spam check, virus check, etc.) on the e-mail. Further, the mail information transfer service 32 extracts from the e-mail various kinds of mail information (for example, a domain name, a local part, a body, a subject, a tenant identifier (ID), and the like of a transmission source address, a transmission destination address, and a mail address) and the attached file, and transfers the mail information and the attached file to the cloud server 100 in response to a POST request of Hypertext Transfer Protocol (HTTP).

The cloud server 100 includes a mail processing module 112, a temporary file storage module 114, an authentication module 116, an event notification module 118, an application management module 120, and an Input/Output (I/O) service 122.

The mail processing module 112 is an example of an acquisition unit and an identification information issuing unit. The mail processing module 112 receives the mail information and the attached file transferred from the mail transfer server 30. Then, the mail processing module 112 causes the authentication module 116 described later to perform authentication, on the basis of the received mail information, thereby acquiring an access token from the authentication module 116. In addition, the mail processing module 112 causes the temporary file storage module 114 described later to store the received mail information and the attached file, and acquires an addresses of a storage destination of the mail address and an address of a storage destination of the attached file from the temporary file storage module 114. In addition, the mail processing module 112 issues a mail ID, which is identification information for identifying the addresses of the storage destinations of the mail information and the attached file. Further, the mail processing module 112 makes an event registration request to the event notification module 118 described later, thereby causing the event notification module 118 notify an event.

The temporary file storage module 114 is an example of a storing unit. The temporary file storage module 114 temporarily stores the mail information and the attached file in response to the storage request from the mail processing module 112. Then, the temporary file storage module 114 transmits the addresses of the storage destinations of the mail information and the attached file to the mail processing module 112.

The authentication module 116 is an example of an authenticating unit. In response to the authentication request from the mail processing module 112, the authentication module 116 authenticates a user who has transmitted the mail information. For example, the authentication module 116 uses, as authentication information, the transmission source address, the transmission destination address, and the tenant ID included in the mail information, and when the authentication information is authentication information registered in advance in an authentication information database, the authentication module 116 determines that the user who has transmitted the mail information is an authorized user. Then, when the authentication module 116 determines that the user who has transmitted the mail information is the authorized user, the authentication module 116 issues an access token and returns the access token to the mail processing module 112. Further, in response to a confirmation request from each processing module, the authentication module 116 determines whether the access token is valid and returns a result of the determination to the processing module that is a source of the confirmation request.

The event notification module 118 is an example of an event notifying unit. In response to the event registration request from the mail processing module 112, the event notification module 118 refers to an event notification setting file corresponding to the event registration request, thereby confirming a type of event, a notification destination and the like corresponding to the event registration request. Then, in accordance with a setting of the event notification setting file, the event notification module 118 notifies a confirmed notification destination (the application management module 120 described later) of an event.

The application management module 120 is an example of an identifying unit, a job registering unit, an application managing unit, and an address generating unit. For example, the application management module 120 stores an application instance ID for identifying an application, a tenant ID, and a request destination uniform resource locator (URL) of a workflow to be executed in association with one another in an IO flow management table. In addition, the application management module 120 refer to the IO flow management table to identify the request destination URL of the workflow to be executed on the basis of the application instance ID and the tenant ID. Then, the application management module 120 transmits a job execution request to the URL to register the workflow to be executed in the I/O service 122 and causes the I/O service 122 to execute the workflow.

In addition, the application management module 120 manages a plurality of applications generated for each workflow. In the application, contents, an order, parameters, and the like of a series of a plurality of processes to be sequentially executed by a workflow are set. Each application can be identified by the application instance ID assigned when the application is generated. For example, a terminal device connected to the cloud server 100 generates the application and changed the setting.

The I/O service 122 is an example of a workflow executing unit. The I/O service 122 controls execution of various workflows. For example, the I/O service 122 executes a job of a workflow registered by the application management module 120. To execute the job of the workflow, the I/O service 122 identifies a workflow to be executed from among a plurality of executable workflows on the basis of the request destination URL of the job execution request transmitted from the application management module 120. In addition, the I/O service 122 acquires the temporarily stored attached file from the temporary file storage module 114, and executes the job of the workflow with the use of the attached file. The I/O service 122 executes the workflow in accordance with the setting of the application corresponding to the workflow to be executed (for example, the contents, the order, the parameters and the like of the plurality of processes).

Each function of the cloud server 100 described above is implemented by the CPU 101 executing a program stored in the ROM 102 or the HDD 104 in the cloud server 100, for example. The program executed by the CPU 101 can be provided in advance in the cloud server 100, or can be provided from extraneous resources and installed in the cloud server 100. In a latter case, this program can be provided by an external storage medium (for example, a USB memory, a memory card, a CD-ROM, etc.), or can be provided by being downloaded from a server or the like on a network (e.g., the Internet).

Steps in Operation by the Information Processing System 10:

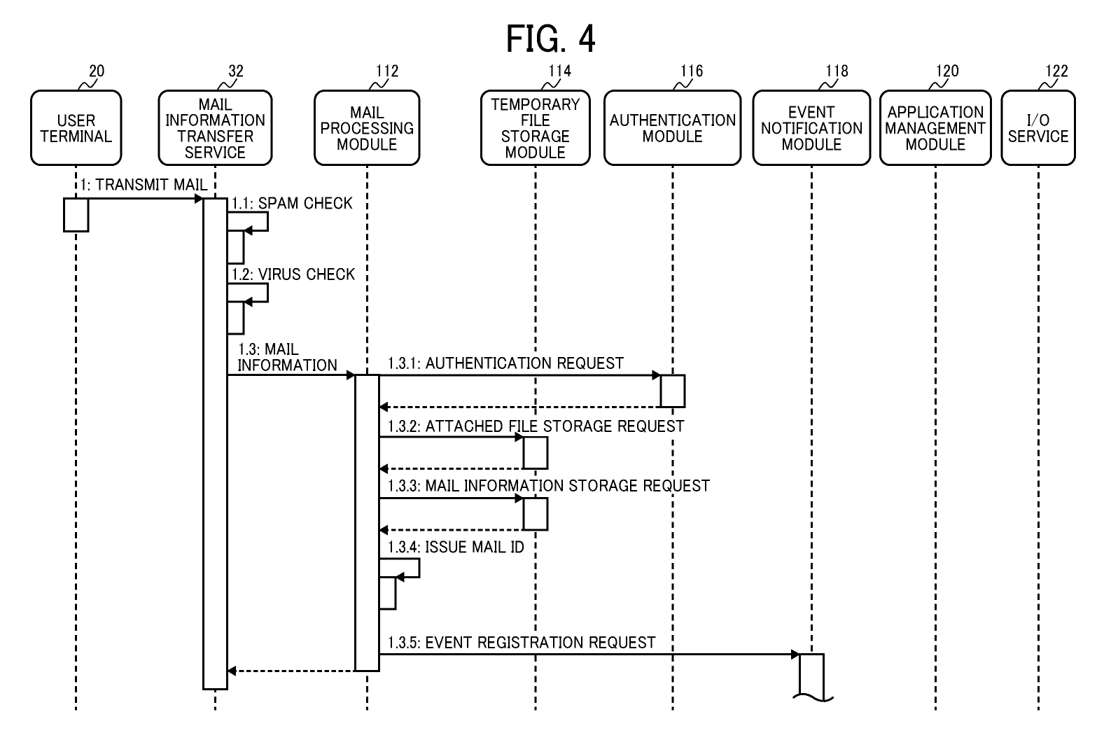

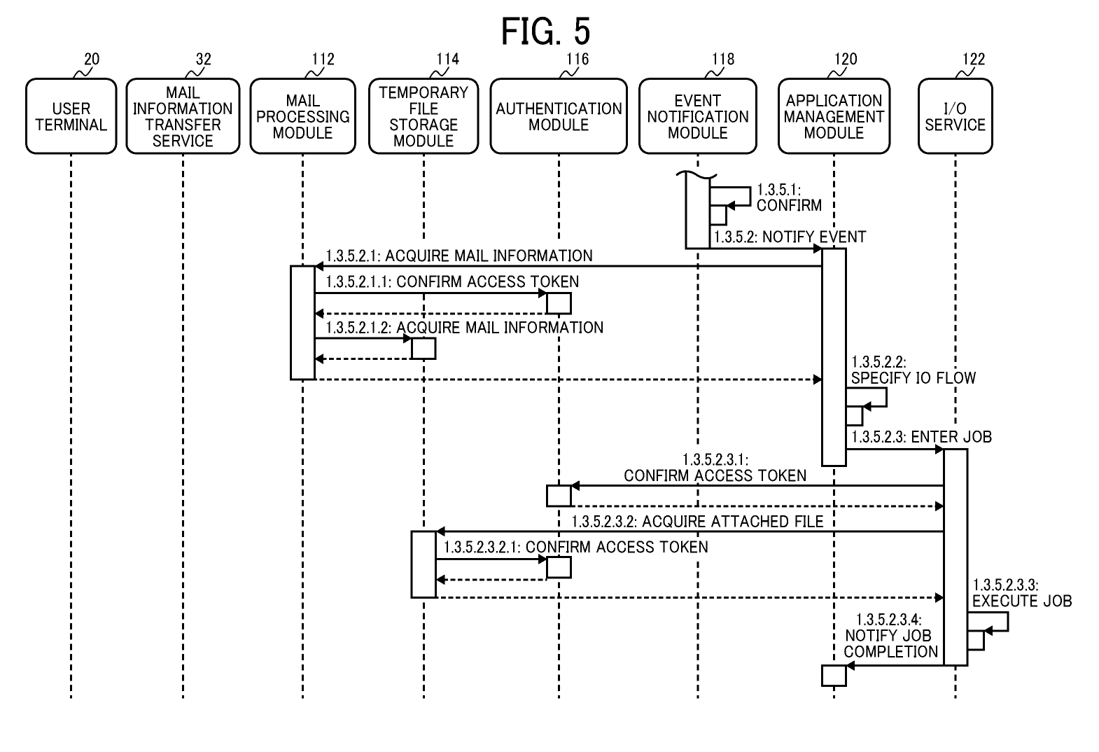

FIGS. 4 and 5 are sequence diagrams illustrating an example of steps in an operation performed by the information processing system 10 according to the embodiment of the present disclosure.

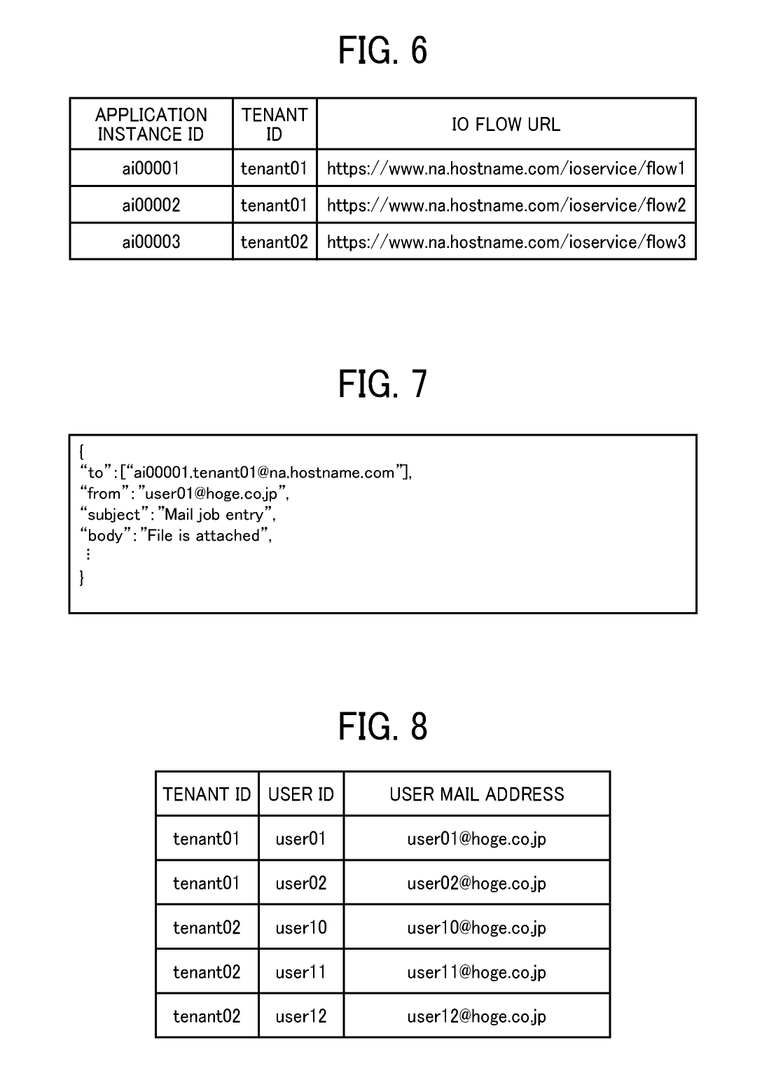

First, as illustrated in FIG. 4, the user terminal 20 transmits an e-mail (S1). A transmission destination address of the e-mail has a configuration of “{application instance ID}.{tenant ID}@{environment name}.{host name}”. The application instance ID is identification information corresponding to the workflow to be executed. The tenant ID is identification information assigned to a tenant (organization) to which the user of the transmission source of the e-mail belongs. That is, in the information processing system 10 according to the present embodiment, the user can specify the application instance ID and the tenant ID from the transmission destination address of the e-mail. For example, when the application instance ID is “ai00001”, the tenant ID is “tenant01”, the environment name is “na”, and the host name is “hostname.com”, the transmission destination address of the e-mail is “ai00001.tenant01@na.hostname.com”. The application management module 120 holds the IO flow management table in which the application instance ID, the tenant ID, and the request destination URL of the workflow to be executed are associated with one another. By using the IO flow management table, the application management module 120 can identify the workflow to be executed on the basis of the application instance ID and the tenant ID set in the e-mail transmitted from the user terminal 20. An example of the IO flow management table held by the application management module 120 will be described later with reference to FIG. 6.

Next, in the mail transfer server 30, when the mail information transfer service 32 receives the e-mail transmitted from the user terminal 20, the mail information transfer service 32 checks whether the e-mail is a spam mail (S1.1). In addition, the mail information transfer service 32 checks whether the e-mail is infected with a virus (S1.2). Then, the mail information transfer service 32 extracts from the e-mail the mail information (for example, the transmission source address, the transmission destination address, the tenant ID, etc.) and the attached file, and transfers the mail information and the attached file to the cloud server 100 in response to a POST request of HTTP (S1.3). An example of the mail information transferred from the mail transfer server 30 to the cloud server 100 will be described later with reference to FIG. 7.

Next, in the cloud server 100, when the mail processing module 112 receives the mail information and the attached file transferred from the mail transfer server 30, the mail processing module 112 transmits to the authentication module 116 an authentication request of the user who has transmitted the mail information (S1.3.1). In response to the authentication request, the authentication module 116 authenticates the user who has transmitted the mail information. Specifically, the authentication module 116 holds a user registration information table in which a user ID (user identification information) and a user mail address are associated with each other. Then, the authentication module 116 refers to the user registration information table to determine whether there is a user ID associated a combination of the tenant ID included in the transmission destination address of the mail information and the transmission destination address (user mail address) of the mail information. Then, based on the determination that there is the associated user ID, the authentication module 116 determines that the user authentication has been succeeded, issues an access token and transmits the access token to the mail processing module 112. An example of the user registration information table held by the authentication module 116 will be described later with reference to FIG. 8.

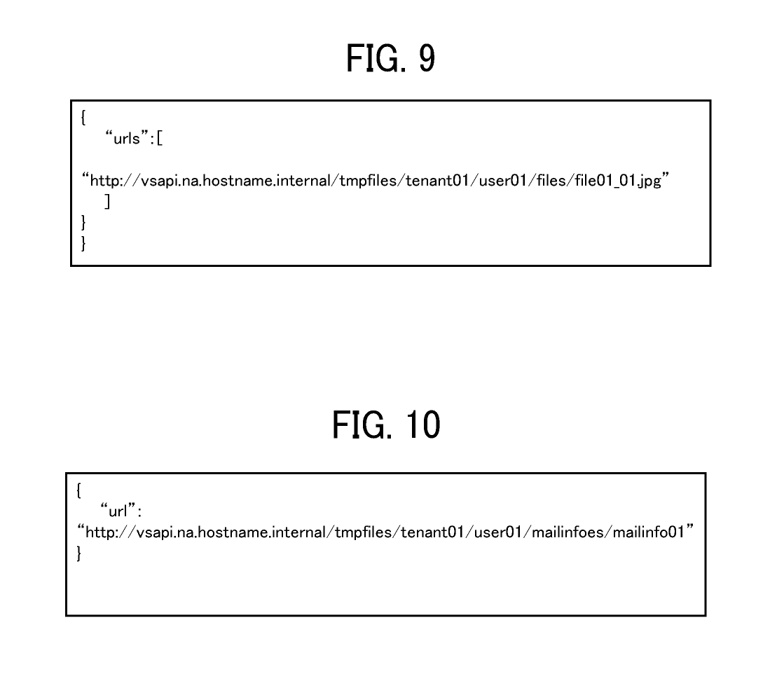

Next, the mail processing module 112 transmits an attached file storage request to the temporary file storage module 114 (S1.3.2). The temporary file storage module 114 stores the attached file in response to the storage request. Then, the temporary file storage module 114 transmits an address of the storage destination of the attached file to the mail processing module 112. An example of the address of the storage destination of the attached file transmitted from the temporary file storage module 114 will be described later with reference to FIG. 9.

In addition, the mail processing module 112 transmits a mail information storage request to the temporary file storage module 114 (S1.3.3). The temporary file storage module 114 stores the mail information in response to the storage request. Then, the temporary file storage module 114 transmits an address of the storage destination of the mail information to the mail processing module 112. An example of the address of the storage destination of the mail information transmitted from the temporary file storage module 114 will be described later with reference to FIG. 10.

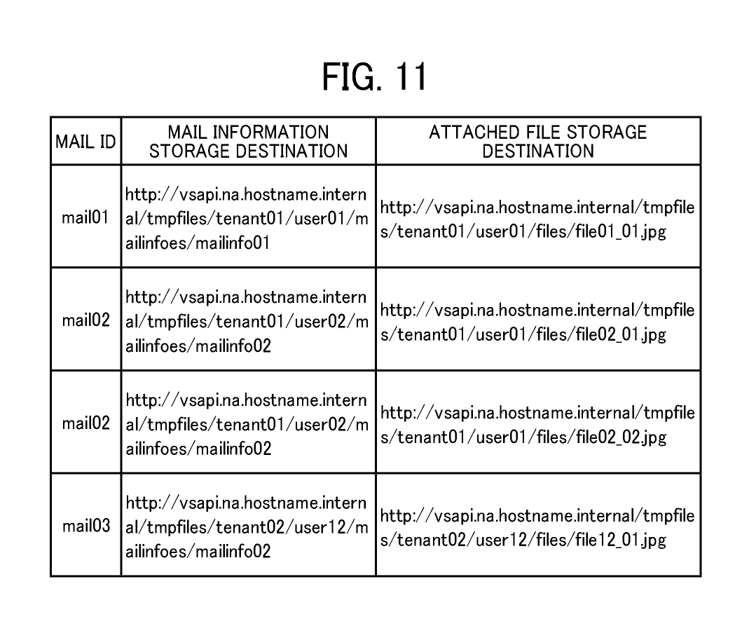

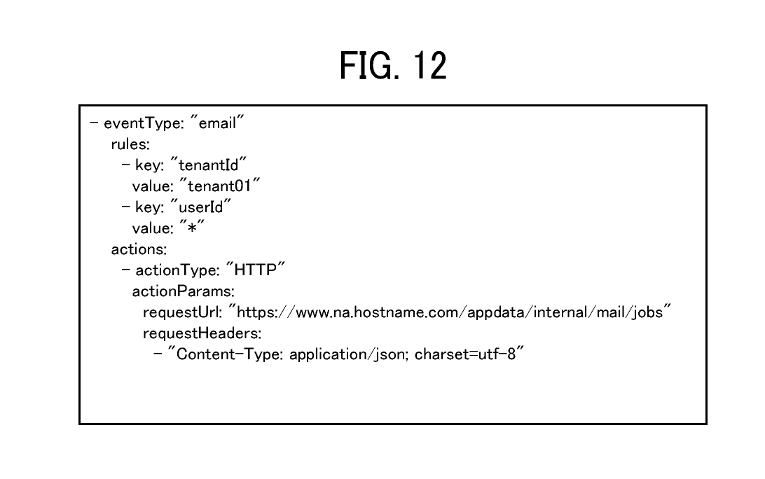

Then, the mail processing module 112 issues a mail ID (S1.3.4), and registers the mail ID, the address of the storage destination of the attached file, and the address of the storage destination of the mail information in association with one another in a mail information management table. An example of the mail information management table held by the mail processing module 112 will be described later with reference to FIG. 11.

Further, the mail processing module 112 transmits an event registration request to the event notification module 118 (S1.3.5). The event registration request includes the access token, the tenant ID, the user ID, and the mail ID as parameters.

Subsequently, as illustrated in FIG. 5, upon receiving the event registration request transmitted from the mail processing module 112, the event notification module 118 confirms a notification destination and content of the event notification (S1.3.5.1). Specifically, the event notification module 118 holds a setting file of the event notification setting in advance. Then, upon receiving the event registration request from the mail processing module 112, the event notification module 118 refers to the setting file corresponding to the event registration request, thereby confirming the notification destination and content of the event notification.

Then, the event notification module 118 notifies the application management module 120 of an event, on the basis of the confirmed notification destination and content (S1.3.5.2). The event notification includes the access token, the tenant ID, the user ID, and the mail ID as parameters.

Upon receiving the event notification from the event notification module 118, the application management module 120 transmits a mail information acquisition request to the mail processing module 112 (S1.3.5.2.1). The acquisition request includes the access token and the mail ID as parameters.

Upon receiving the mail information acquisition request transmitted from the application management module 120, the mail processing module 112 transmits to the authentication module 116 a confirmation request of the access token included in the acquisition request (S 1.3.5.2.1.1). Upon receiving the confirmation request, the authentication module 116 determines whether the access token is a valid access token, and returns a result of the determination to the mail processing module 112.

In addition, upon receiving the mail information acquisition request transmitted from the application management module 120, the mail processing module 112 transmits to the temporary file storage module 114 an acquisition request of the addresses of the storage destinations of the mail information and the attached file corresponding to the mail ID included in the acquisition request (S1.3.5.2.1.2). Upon receiving the acquisition request, the temporary file storage module 114 acquires from the mail information management table the addresses of the storage destinations of the mail information and the attached file corresponding to the mail ID, and transmits to the mail processing module 112 the addresses of the storage destinations of the mail information and the attached file corresponding to the mail ID. The mail processing module 112 transmits to the application management module 120 the addresses of the storage destinations of the mail information and the attached file.

Upon receiving the addresses of the storage destinations of the mail information and the attached file, that are transmitted from the mail processing module 112, the application management module 120 refers to the mail information stored in the address to identify the application instance ID on the basis of the transmission destination address included in the mail information. Then, the application management module 120 refers to the IO flow management table (see FIG. 6) held by the application management module 120 itself, to identify the URL of the workflow associated with the application instance ID (S1.3.5.2.2). Further, the application management module 120 transmits a job execution request to the URL (S1.3.5.2.3). This execution request includes the access token and the address of the storage destination of the attached file.

Upon receiving the job execution request transmitted from the application management module 120, the I/O service 122 transmits to the authentication module 116 a confirmation request of the access token included in the execution request (S1.3.5.2.3.1). Upon receiving the confirmation request, the authentication module 116 determines whether the access token is a valid access token, and returns a result of the determination to the I/O service 122.

Then, the I/O service 122 transmits an attached file acquisition request to the temporary file storage module 114 (S1.3.5.2.3.2). This acquisition request includes the access token and the address of the storage destination of the attached file.

Upon receiving the attached file acquisition request transmitted from the I/O service 122, the temporary file storage module 114 transmits to the authentication module 116 a confirmation request of the access token included in the acquisition request (S1.3.5.2.3.2.1). Upon receiving the confirmation request, the authentication module 116 determines whether the access token is a valid access token, and returns a result of the determination to the temporary file storage module 114.

Then, the temporary file storage module 114 acquires the attached file from the address of the storage destination of the attached file, that is included in the attached file acquisition request transmitted from the I/O service 122, and transmits the attached file to the I/O service 122.

Upon receiving the attached file transmitted from the temporary file storage module 114, the I/O service 122 uses the attached file to execute the job of the work flow specified by the URL to which the job execution request has been transmitted from the application management module 120 (S1.3.5.2.3.3). Then, the I/O service 122 transmits a job completion notification to the application management module 120.

Example of the 10 Flow Management Table Held by the Application Management Module 120:

FIG. 6 is a diagram illustrating an example of the IO flow management table held by the application management module 120 according to an embodiment of the present disclosure. As illustrated in FIG. 6, in the I0 flow management table, the request destination URL (IO flow URL) of the workflow to be executed is associated with the application instance ID and the tenant ID. With this, the application management module 120 refers to the IO flow management table to identify the workflow to be executed on the basis of the application instance ID and the tenant ID set in the transmission destination address of the e-mail transmitted from the user terminal 20.

Example of the Mail Information Transferred to the Cloud Server 100:

FIG. 7 is a diagram illustrating an example of the mail information transferred from the mail transfer server 30 to the cloud server 100 in the information processing system 10 according to an embodiment of the present disclosure. In FIG. 7, as an example, the mail information transferred from the mail transfer server 30 to the cloud server 100 when an e-mail with a destination address of “ai00001.tenant01@na.hostname.com” is transmitted from the user terminal 20 is indicated.

In the mail information illustrated in FIG. 7, “ai00001.tenant01@na.hostname.com” set to “to” indicates the transmission destination address set in the e-mail transmitted from the user terminal 20. This transmission destination address includes the application instance ID “ai00001” and the tenant ID “tenant 01” in a local part. That is, with this transmission destination address, it is possible to specify the workflow to be executed on the basis of the IO flow management table.

In addition, “user01@hoge.co.jp” set in “from” indicates the transmission source address set in the e-mail transmitted from the user terminal 20. The transmission source address includes user identification information “user 01” in the local part. Moreover, “Mail job entry” set in “subject” indicates a subject name set in the e-mail transmitted from the user terminal 20. Furthermore, “File is attached” set in “body” indicates a body set in the e-mail transmitted from the user terminal 20.

By receiving the mail information such as the mail information illustrated in FIG. 7 from the mail transfer server 30, the cloud server 100 can execute the workflow identified on the basis of the mail information (application instance ID and tenant ID) by using attached file that is transferred together with the mail information.

Example of the User Registration Information Table:

FIG. 8 is a diagram illustrating an example of the user registration information table held by the authentication module 116 according to an embodiment of the present disclosure. As illustrated in FIG. 8, in the user registration information table, the tenant ID and the user mail address are associated with the user ID. With this, the authentication module 116 refers to the user registration information table to determine whether there is a user ID associated with the combination of the tenant ID included in the transmission destination address of the mail information and the transmission destination address of the mail information. Then, based on the determination that there is the associated user ID, the authentication module 116 determines that the user authentication has been succeeded and can issue the access token.

Example of the Address of the Storage Destination of the Attached File:

FIG. 9 is a diagram illustrating an example of the address of the storage destination of the attached file transmitted from the temporary file storage module 114 according to an embodiment of the present disclosure. FIG. 9 indicates an example of data transmitted from the temporary file storage module 114 to the mail processing module 112 when the temporary file storage module 114 stores the attached file in response to the request from the mail processing module 112. In this data, “http://vsapi.na.hostname.internal/tmpfiles/tenant01/user01/files/file01_01.jpg” set in “urls” indicates the address of the storage destination of the attached file.

Example of the Address of the Storage Destination of the Mail Information:

FIG. 10 is a diagram illustrating an example of the address of the storage destination of the mail information transmitted from the temporary file storage module 114 according to an embodiment of the present disclosure. FIG. 10 indicates an example of data transmitted from the temporary file storage module 114 to the mail processing module 112 when the temporary file storage module 114 stores the mail information in response to the request from the mail processing module 112. In this data, “http://vsapi.na.hostname.internal/tmpfiles/tenant01/user01/mailinfoes/mailinfo01” set in “url” in the data indicates the address of the storage destination of the mail information.

Example of the Mail Information Management Table:

FIG. 11 is a diagram illustrating an example of the mail information management table held by the mail processing module 112 according to an embodiment of the present disclosure. As illustrated in FIG. 11, in the mail information management table, the address of the storage destination of the mail information and the address of the storage destination of the attached file are associated with the mail ID. When the temporary file storage module 114 stores the mail information and the attached file, the address of the storage destination of the mail information and the address of the storage destination of the attached file are returned from the temporary file storage module 114 to the mail processing module 112. The mail ID is issued to these addresses by the mail processing module 112 when the mail processing module 112 receives the address of the storage destination of the mail information and the address of the storage destination of the attached file. With this, when receiving the mail information acquisition request from other modules, the mail processing module 112 refers to the mail information management table, to acquire, on the basis of the mail ID included in the acquisition request, the address of the storage destination of the mail information and the address of the storage destination of the attached file, associated with the mail ID.

Example of the Setting File of the Event Notification Setting:

FIG. 12 is a diagram illustrating an example of the setting file of the event notification setting held by an event notification module 118 according to an embodiment of the present disclosure.

In the setting file illustrated in FIG. 12, “eventType” indicates a type of event to be notified. For example, in the example illustrated in FIG. 12, “email” is set as the “eventType”, indicating that the setting file is an event notification setting file corresponding to the event registration request from the mail processing module 112.

In the setting file illustrated in FIG. 12, “rules” indicates conditions for performing event notification. For example, in the example illustrated in FIG. 12, “rules” includes the tenant ID (tenantId) and the user ID (userId) as the conditions. Specifically, in the setting file illustrated in FIG. 12, “tenant01” is set as the tenant ID. In addition, in the setting file illustrated in FIG. 12, “*” is set as the user ID. This indicates that the setting file is a setting file to be applied to all the user IDs belonging to the tenant ID “tenant01”.

Also, in the setting file illustrated in FIG. 12, “actions” indicates a notification destination of an event and a method for notifying the event. For example, in the example illustrated in FIG. 12, “actions” includes “actionType”, “requestUrl”, and “requestHeaders” as conditions.

In the “actionType”, a method for notifying the event is set. For example, in the example illustrated in FIG. 12, “HTTP” is set in the “actionType”. This means that the event notification is performed by HTTP request.

In the “requestUrl”, the URL of the notification destination of the event is set. For example, in the example illustrated in FIG. 12, “https://www.na.hostname.com/appdata/internal/mail/jobs” is set in the “requestUrl”. This URL is an application programming interface (API) path for receiving the event notification included by the application management module 120.

In the “requestHeaders”, a value to be added to a header of the HTTP request at the event notification is set. For example, in the example illustrated in FIG. 12, “Content-Type: application/json; charset=utf-8” for specifying a content type and a character code is set for the “requestHeaders”.

In response to the event registration request from the mail processing module 112, the event notification module 118 refers to the event notification setting file corresponding to the event registration request, such as the event notification setting file illustrated in FIG. 12, to confirm a type of event, a notification destination and the like corresponding to the event registration request. Then, in accordance with a setting of the event notification setting file, the event notification module 118 notifies a confirmed notification destination (the API path for receiving the event notification included by the application management module 120) of an event.

Example of a Workflow Setting Screen:

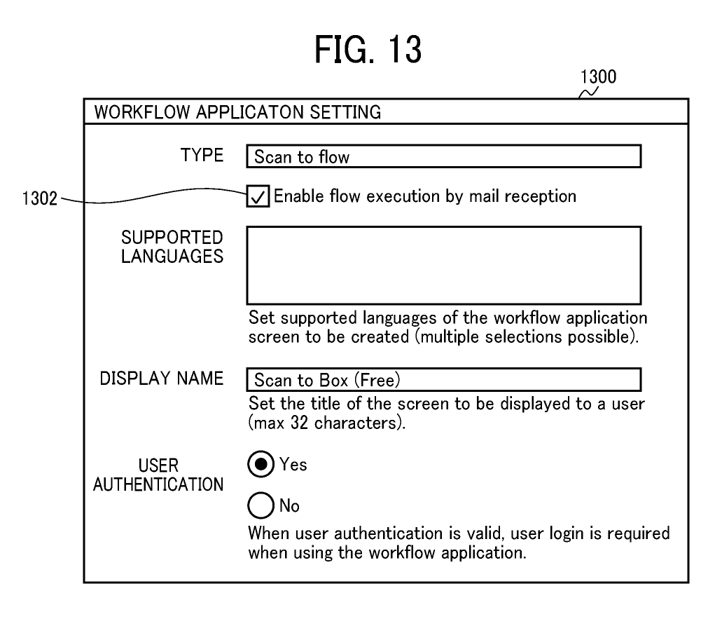

FIG. 13 is a diagram illustrating an example of an application setting screen displayed on a display of a terminal device connected to the cloud server 100, according to an embodiment of the present disclosure. As described above, in the cloud server 100, an application is generated in which various settings on the workflow (for example, contents, an order, parameters and the like of a plurality of processes) are configured for each workflow. This application is generated and managed by the application management module 120. In addition, the I/O service 122 executes the workflow in accordance with the settings of this application. For example, an administrative user of the application can generate an application and change the settings from a terminal device connected to the cloud server 100. A setting screen 1300 illustrated in FIG. 13 is an example of an application setting screen displayed on a display of the terminal device when generating an application and changing the settings.

As illustrated in FIG. 13, the setting screen 1300 includes a check box 1302. The check box 1302 is for enabling an execution of the workflow triggered from an e-mail. For example, when an application is generated in a state where a mark is put in the check box 1302, the application can execute the workflow from an e-mail.

When creating the application, the application management module 120 assigns the application instance ID to the application. In addition, the application management module 120 automatically generates a transmission destination mail address for executing the application by using the application instance ID and the tenant ID set for the application. With this, the transmission destination mail address and the application are associated with each other. That is, by transmitting an e-mail to this transmission destination mail address, it is possible to execute a workflow corresponding to this application.

The application is used not only for executing a workflow triggered from an e-mail but also for executing a workflow triggered from other execution methods (for example, scanning by an MFP connected to the cloud server 100, etc.). That is, this application is shared by a plurality of types of execution methods, and by changing a setting of the application, the change of the setting is reflected in the plurality of types of execution methods.

In addition, on the application setting screen, it is possible to set a tenant ID and a user ID that permit a use of the application. That is, by changing the setting of the tenant ID and the user ID to which permission of the use of the application is granted on the application setting screen, it is possible to reflect the setting change in the plurality of types of execution methods.

As described above, the information processing system 10 according to an embodiment of the present disclosure can acquire mail information included in an e-mail and an attached file attached to the e-mail, identify a workflow to be executed on the basis of the mail information, and execute the identified workflow with the use of the attached file. Specifically, the information processing system 10 according to an embodiment of the present disclosure includes identification information of the workflow to be executed in the mail information included in the e-mail transmitted from the user terminal 20, and a desired workflow can thereby be selectively executed among a plurality of workflows. Therefore, according to the information processing system 10 of an embodiment of the present disclosure, it is possible to transmit an e-mail attached to which an electronic file is attached to execute various functions using the attached file. In addition, according to the information processing system 10 of an embodiment of the present disclosure, it is possible to execute a workflow from any terminal device including a function of transmitting an e-mail.

In particular, the information processing system 10 according to an embodiment of the present disclosure can identify a workflow to be executed on the basis of a transmission destination address of an e-mail included in mail information. That is, the information processing system 10 according to an embodiment of the present disclosure includes identification information of the workflow to be executed in the transmission destination address of the e-mail instead of configuring special settings for a body or the like of the e-mail, and a desired workflow can thereby be selectively executed among a plurality of workflows. Therefore, according to the information processing system 10 of an embodiment of the present disclosure, it is possible to easily and reliably designate a workflow to be executed from the user terminal 20.

In addition, the information processing system 10 according to an embodiment of the present disclosure performs setting for an application to associate a transmission destination address with a workflow. Specifically, the information processing system 10 according to an embodiment of the present disclosure can automatically generate a transmission destination address associated with a workflow when generating an application. Therefore, according to the information processing system 10 of an embodiment of the present disclosure, it is possible to easily and reliably associate a workfl ow with a transmission destination address for executing the workflow.

In addition, the information processing system 10 according to an embodiment of the present disclosure can be used not only for executing a workflow triggered from an e-mail but also for executing workflows triggered from other execution methods. Therefore, according to the information processing system 10 of the embodiment of the present disclosure, it is possible to change a setting of an application and thereby reflect a setting change in a plurality of types of execution methods including execution of a workflow triggered from an e-mail.

In particular, the information processing system 10 according to an embodiment of the present disclosure can include a setting related to a user who is permitted to execute a workflow. Therefore, according to the information processing system 10 of an embodiment of the present disclosure, it is possible to share the setting related to the user who is permitted to execute the workflow among a plurality of types of execution methods.

In addition, the information processing system 10 according to the embodiment of the present disclosure can authenticate, a user who has transmitted an e-mail, on the basis of a tenant ID set in a transmission destination address of the e-mail and a user ID identified by a transmission source address of the e-mail. Therefore, according to the information processing system 10 of the embodiment of the present disclosure, it is possible to easily and reliably authenticate the user who has transmitted the e-mail without configuring special settings for a body or the like of the e-mail.

In addition, the information processing system 10 according to an embodiment of the present disclosure can issue an access token when a user who has transmitted an e-mail is successfully authenticated, and based on this access token, the success of authentication is confirmed. With this, the information processing system 10 according to the embodiment of the present disclosure can manage with the access token the authentication success of the user who has transmitted the e-mail, and can pass the access token between modules. Each module can confirm the authentication success of the user who has transmitted the e-mail with the use of the access token as needed.

In addition, the information processing system 10 according to an embodiment of the present disclosure can temporarily store mail information and an attached file and issue identification information (mail ID) for accessing the stored mail information and the attached file. With this, the information processing system 10 according to an embodiment of the present disclosure can manage the mail information and the attached file by using the identification information and pass the identification information between modules. Each module can acquire the mail information and the attached file with the use of the identification information as needed.

While the embodiments of the present disclosure have been described in detail, the present disclosure is not limited to these embodiments, and various modifications or changes may be made within the scope of the present disclosure described in the claims.

For example, in the abovementioned embodiment, a part or all of the functions included in the cloud server 100 may be provided in one or a plurality of other information processing apparatuses (for example, a server apparatus, a personal computer, an MFP, etc.) included in the information processing system 10.

In addition, for example, in the above embodiment, while the tenant ID and the application instance ID are included in the transmission destination address of the e-mail, the present disclosure is not limited to this configuration, and for example, the tenant ID and the application instance ID may be included in a body, title or the like of an e-mail.

Further, for example, in the above embodiment, while the cloud server 100 acquires the mail information and the attached file from the mail transfer server 30, the present disclosure is not limited to this configuration. For example, the cloud server 100 may receive an e-mail transmitted from the user terminal 20 and acquire the mail information and the attached file from the e-mail.

According to a conventional technique, by transmitting an e-mail to which an electronic file is attached, a print job using the attached file can be executed. However, according to the conventional technique, it is not possible to selectively execute various functions using the attached file.

According to an embodiment of the present disclosure, various functions using electronic data are executed by transmitting an electronic mail to which the electronic data is attached.

Any one of the above-described operations may be performed in various other ways, for example, in an order different from the one described above.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information processing system for executing a workflow including a plurality of processes to be executed in series, the information processing system comprising:
circuitry configured to
acquire mail information included in an e-mail and electronic data attached to the e-mail;
identify a workflow to be executed based on the mail information; and
execute the identified workflow with a use of the electronic data.

2. The information processing system according to claim 1, wherein
the circuitry is further configured to identify the workflow to be executed based on a transmission destination address of the e-mail included in the mail information.

3. The information processing system according to claim 2, wherein
the circuitry is further configured to manage an application in which a setting related to the workflow is configured, and
the application includes a setting for associating the transmission destination address and the workflow with each other.

4. The information processing system according to claim 3, wherein
the circuitry is further configured to automatically generate the transmission destination address to be associated with the workflow when generating the application.

5. The information processing system according to claim 3, wherein
the application is shared by execution of the workflow triggered from a plurality of execution methods including execution of the workflow triggered from the e-mail.

6. The information processing system according to claim 5, wherein
the application includes a setting related to a user who is permitted to execute the workflow.

7. The information processing system according to claim 1, wherein
the circuitry is further configured to authenticate a user who transmits the e-mail based on organization identification information specified by a transmission destination address of the e-mail and user identification information specified by a transmission source address of the e-mail.

8. The information processing system according to claim 1, wherein
the circuitry is further configured to
temporarily store the mail information and the electronic data; and
issue identification information for accessing the mail information and the electronic data that are temporarily stored.

9. The information processing system according to claim 8, wherein
the circuitry executes a module to specify the workflow to be executed based on the mail information,
the circuitry is further configured to notify the module of an event including the identification information,
the module acquires the mail information that is temporarily stored by using the identification information, and
the circuitry specifies the workflow to be executed based on the mail information acquired by using the identification information.

10. The information processing system according to claim 1, further comprising:
a mail transfer server configured to
receive the e-mail transmitted from a terminal device; and
transfer to the circuitry the mail information included in the e-mail and the electronic data attached to the e-mail.

11. The information processing system according to claim 10, wherein
the mail transfer server transfers the mail information and the electronic data to the circuitry by an HTTP POST request.

12. An information processing apparatus for executing a workflow including a plurality of processes to be executed in series, the information processing apparatus comprising:
circuitry configured to
acquire mail information included in an e-mail and electronic data attached to the e-mail;
identify a workflow to be executed based on the mail information; and
execute the identified workflow with a use of the electronic data.

13. An information processing method for executing a workflow including a plurality of processes to be executed in series, the information processing method comprising:
acquiring mail information included in an e-mail and electronic data attached to the e-mail;
identifying a workflow to be executed based on the mail information; and
executing the identified workflow with a use of the electronic data.
